(19) United States
(12) Patent Application Publication
(10) Pub. No.: US 2019/0287140 A1
(43) Pub. Date: Sep. 19, 2019

(54) METHOD AND SYSTEM FOR VEHICLE VALUATION USING TELEMATICS

(71) Applicant: MASTERCARD INTERNATIONAL INCORPORATED, Purchase, NY (US)

(72) Inventors: Ankur ARORA, Jasola (IN); Shubham BIJAWAT, Gurgaon (IN); Jaipal Singh KUMAWAT, Sikar (IN); Avinash KUMAR, Bokaro (IN); Avdhesh VYAS, Gurgaon (IN); Srishti GUPTA, Dadabari (IN)

(73) Assignee: MASTERCARD INTERNATIONAL INCORPORATED, Purchase, NY (US)

(21) Appl. No.: 15/924,408

(22) Filed: Mar. 19, 2018

(51) Int. Cl. G06Q 30/02; G06F 17/30; G06Q 40/08

(52) U.S. Cl. CPC G06Q 30/0278; G06Q 40/08; G06F 17/30864

(57) ABSTRACT

A method for valuation of a vehicle based on telematics includes: storing a plurality of vehicle profiles, each related to a vehicle including a vehicle value and associated telematics data points; receiving a plurality of telematics data points associated with a target vehicle; identifying a subset of vehicle profiles where there is a correspondence between the associated telematics data points and the received plurality of telematics data points; estimating a valuation of the target vehicle based on, for each vehicle profile in the subset, a combination of the vehicle value included in the respective vehicle profile and a level of similarity to the received plurality of telematics data points and the associated telematics data points; and transmitting the estimated valuation to an external computing device.

### FIELD

The present disclosure relates to the valuation of vehicles using telematics, specifically the analysis of telematics data for a vehicle as matched to telematics data for other vehicles for whom a value is known for use in estimating the value of the initial vehicle.

### BACKGROUND

Vehicles are valued for a variety of different reasons: sale, resale, insurance, repair, taxation, collateral, etc. Entities involved in the process of providing a valuation of a vehicle often use a vast number of different methods. Some rely on general estimates of value that are then tailored based on a personal or provided examination of the vehicle. Others focus primarily on an examination by an authorized party. Yet others may rely solely on self-reporting of an individual requesting the valuation. Still others may use estimations that are based purely on objective characteristics of the vehicle (e.g., year, make, model, etc.) without regard as to the condition of the vehicle. Because of these different types of valuations, it may be exceedingly difficult for an individual or other entity to identify a suitable estimate as to the value of a specific vehicle.

One method that many entities often rely on is comparing the vehicle to others for which a value is known. For instance, if several cars having the same make, model, year, trim, and mileage were sold, the value for sale of the initial vehicle could be estimated to be similar to the sale value of the other cars. However, additional characteristics, such as condition, of the initial vehicle and the other vehicles may be different depending on the person or guidelines used in identifying the condition. For instance, an individual providing data about their own vehicle may understate problems, be unaware of problems, or may weigh the problems different from the entity performing the valuation, particularly with respect to the condition of the engine, exhaust system, filters, transmission, and other similar data that may be inaccessible or otherwise unknown by a layman individual. In these cases, the individual may assume that their vehicle has a high value, when it may have transmission or engine issues that would cause a valuating entity to lower this value. However, in many instances, such information may be unavailable to entities that may make use of the data, which may result in an inaccurate valuation being made. Similarly, the individual having the vehicle valuated may be unaware of problems and thus the true value of the vehicle, and only may discover so when the entity performing the valuation discovers the problems and returns a lower-than-anticipated valuation.

Thus, both the individuals and entities having vehicles evaluated as well as the evaluating entities themselves may benefit from a more accurate valuation of a vehicle that does not rely on potentially biased, user-provided data. As such, there is a need for a technological solution to use objective data captured for vehicle, specifically telematics data, to provide for a more accurate valuation of a vehicle based on its past operation.

### SUMMARY

The present disclosure provides a description of systems and methods for valuation of a vehicle based on telematics. Telematics data is captured for a vehicle using a specialized computing device specifically configured to capture such data. Telematics data for vehicles having a known value are gathered and stored in a centralized repository, which can then be used when performing valuations for other vehicles. When a valuation is requested, the telematics data for the vehicle is captured, and then matched to telematics data for vehicles in the repository. As a result, the vehicle can be matched as closely as possible to other vehicles having similar conditions with respect to various vehicle processes, using the telematics data. The values for these matched vehicles, and the strength of the matches, can then be used to identify a more accurate valuation of the target vehicle. The result is the use of the telematics data for a vehicle to provide for a fast, simple, and more accurate valuation of a vehicle, using entirely objective data. In some embodiments, a blockchain may be used for storage of telematics and/or valuation data, which may provide for additional security as to the data being used in valuations and prevent the tampering and falsification of data to further increase the accuracy of valuations.

A method for valuation of a vehicle based on telematics includes: storing, in a vehicle database of a processing server, a plurality of vehicle profiles, wherein each vehicle profile is a structured data set related to a vehicle including at least a vehicle value and a plurality of associated telematics data points; receiving, by a receiving device of the processing server, a plurality of telematics data points associated with a target vehicle; executing, by a querying module of the processing server, to identify a subset of vehicle profiles where there is a correspondence between the included plurality of associated telematics data points and the received plurality of telematics data points; estimating, by an estimation module of the processing server, a valuation of the target vehicle based on, for each vehicle profile in the subset, a combination of the vehicle value included in the respective vehicle profile and a level of similarity to the received plurality of telematics data points and the plurality of associated telematics data points included in the respective vehicle profile; and electronically transmitting, by a transmitting device of the processing server, the estimated valuation to an external computing device.

A system for valuation of a vehicle based on telematics includes: a vehicle database of a processing server configured to store a plurality of vehicle profiles, wherein each vehicle profile is a structured data set related to a vehicle including at least a vehicle value and a plurality of associated telematics data points; a receiving device of the processing server configured to receive a plurality of telematics data points associated with a target vehicle; a querying module of the processing server configured to execute a query to identify a subset of vehicle profiles where there is a correspondence between the included plurality of associated telematics data points and the received plurality of telematics data points; an estimation module of the processing server configured to estimate a valuation of the target vehicle based on, for each vehicle profile in the subset, a combination of the vehicle value included in the respective vehicle profile and a level of similarity to the received plurality of telematics data points and the plurality of associated telematics data points included in the respective vehicle profile; and a transmitting device of the processing server configured to electronically transmit the estimated valuation to an external computing device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for providing valuations for vehicles using telematics in accordance with exemplary embodiments.

FIG. 2 is a block diagram illustrating the processing server of the system of FIG. 1 for the valuation of vehicles using telematics in accordance with exemplary embodiments.

FIG. 3 is a flow diagram illustrating a process for the valuation of a vehicle using telematics data using the system of FIG. 1 in accordance with exemplary embodiments.

FIG. 4 is a flow chart illustrating an exemplary method for valuation of a vehicle based on telematics in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Vehicle Valuations Using Telematics Data

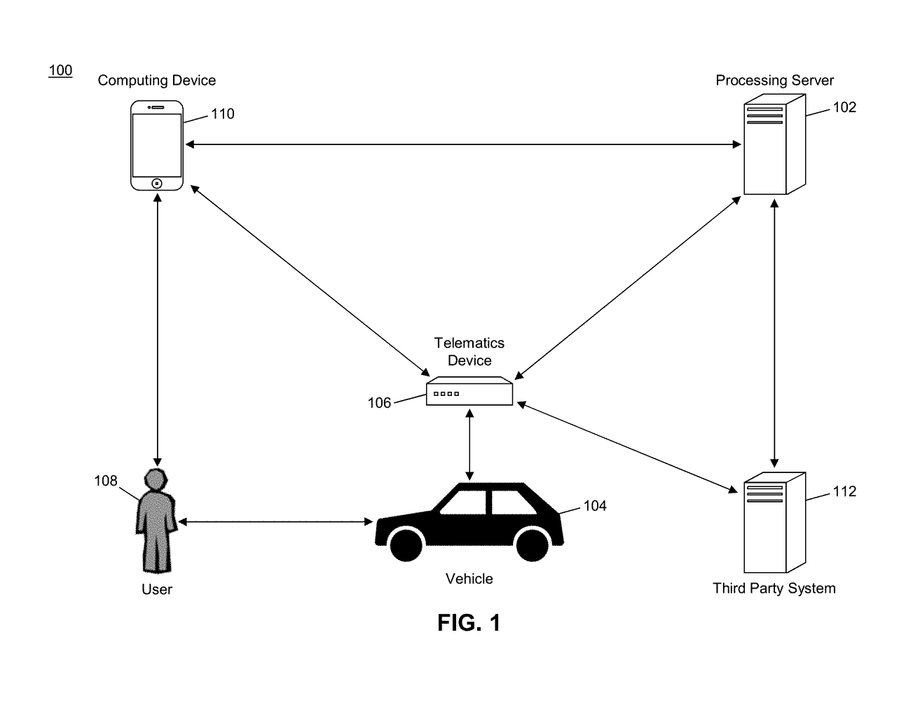

FIG. 1 illustrates a system 100 for the valuation of a vehicle based on telematics data captured for the vehicle compared to telematics for other vehicles having known values.

The system 100 may include a processing server 102. The processing server 102, discussed in more detail below, may be configured to perform a valuation of a vehicle 104, where the valuation may be based on telematics data captured for the vehicle 104. As discussed herein, “vehicle” may refer to an automobile, motorcycle, boat, recreational vehicle, off-road vehicle, all-terrain vehicle, or any other type of vehicle for which telematics data may be captured. In the system 100, the vehicle 104 may be equipped with or otherwise report telematics data to a telematics device 106. The telematics device 106 may be a specifically configured computing device that is physically installed in the vehicle 104 that is configured to read telematics data therefrom or is otherwise configured to receive and process telematics data based on data captured from the vehicle 104 and reported to the telematics device 106. For instance, the telematics device 106 may be part of an on-board computing system used to operate the vehicle 104 as installed by the vehicle manufacturer, or may be an aftermarket device that is installed in the vehicle 104 for the capturing of telematics data. Telematics data may include any data that may be captured from the vehicle 104 associated with the operation thereof, including geographic location, speed, brake time, break pressure, engine revolutions per minute, shifting times, clutch engaging and disengaging, fuel levels, fluid levels, electronics usage, heat usage, air conditioning usage, etc.

The processing server 102 may be configured to receive the telematics data captured from the vehicle 104 by the telematics device 106. In some embodiments, the processing server 102 may be in communication directly with the telematics device 106, where the telematics device 106 may directly report captured telematics data to the processing server 102 at predetermined intervals or upon request by the processing server 102 or a third party. In other embodiments, the telematics device 106 may be configured to report telematics data to a third party system 112, such as associated with a vehicle manufacturer, insurance provider, or other third party. For instance, the third party system 112 may be an insurance provider that provides the telematics device 106 for the measuring of telematics in the vehicle 104 for use thereby in providing insurance, which may also report the telematics data to the processing server 102.

In another embodiment, a user 108 of the vehicle 104 may possess a computing device 110 that is configured to receive telematics data from the telematics device 106, which may provide the telematics data to the processing server 102 using a suitable communication network and method. For instance, the user 108 may use the computing device 110 to submit a valuation request to the processing server 102, as discussed in more detail below, where the request may include the telematics data captured by the telematics device 106. The computing device 110 may be any type of computing device suitable for performing the functions discussed herein, such as a desktop computer, laptop computer, notebook computer, tablet computer, cellular phone, smart phone, smart watch, wearable computing device, implantable computing device, etc. The computing device 110 and processing server 102 may communicate using any suitable network, such as via the Internet, a local area network, a cellular communication network, etc.

The processing server 102 may receive telematics data for a plurality of different vehicles 104 whose value is known. The processing server 102 may then store the telematics data with the associated vehicle value in a database, discussed in more detail below. In some embodiments, the telematics and valuation data may be accompanied by characteristics data for the vehicle 104, which may describe one or more features of the vehicle 104 that may be used in the identification thereof or otherwise assist in the valuation of other vehicles. For instance, the characteristics data may include make, model, year, trim, drive train, wheel size, audio system, and other vehicle features that may be used when comparing multiple vehicles for valuation purposes, but which may not be measured by a telematics device 106. In these embodiments, the characteristics data may be stored along with the telematics data captured for a particular vehicle 104.

In some embodiments, telematics data, and any other data in accompaniment thereof, may be stored in a blockchain. A blockchain may be a decentralized and distributed storage mechanism where data stored therein is immutable. A blockchain may be operated by and stored across a plurality of computing nodes that comprise a blockchain network. The blockchain may be comprised of a plurality of blocks, where each block includes a block header and one or more data values. The block header may include at least a timestamp, a block reference value, and a data reference value. The timestamp may be a representation of the time when the respective block was generated for addition to the blockchain. The block reference value may be a reference to the prior block (e.g., as indicated via timestamp) that was added to the blockchain. The data reference value may be a reference to the one or more data values included in the respective block. In an exemplary embodiment, the block reference value and data reference value may be a hash value generated via hashing of the respective data, such that any modifications to the underlying data would result in a different hash value. As a result, the blockchain may be immutable as any modification to a single block header or data value would necessitate modification to that block's data reference value and/or block reference value, along with the block reference value in every subsequent block in the blockchain, which must be carried out at every node in the entire blockchain before a new block is added, which may be computationally and communicatively impossible. New blocks that are generated by a node in the blockchain network are validated by other nodes in the network prior to addition to the blockchain, using methods that will be apparent to persons having skill in the relevant art, such as proof of work or proof of stake.

In the system 100, a blockchain may be used to store telematics and valuation data for vehicles 104 as data values stored therein. In such embodiments, the telematics device 106 (e.g., or third party system 112, as applicable) may report the vehicle telematics data, along with any other data captured from the vehicle 104 (e.g., characteristics data), to a node in the blockchain network. The node may then generate a new data value to include the received data that is included in a new block that is generated, validated, and added to the blockchain. In these embodiments, the processing server 102 may be configured to receive telematics data via the blockchain data values, where the telematics data may be protected from tampering or falsification due to the use of the blockchain, which may be compounded in instances where telematics devices 106 may report the telematics data directly to blockchain nodes, to prevent tampering of the data by any intermediary third party system 112. In such embodiments, the processing server 102 may not utilize an internal storage and may instead use the blockchain for storage of telematics and valuation data. In some cases, the processing server 102 may be a node in the blockchain network, and may store the blockchain, and thus the telematics data, accordingly. In cases where telematics data may be directly reported by the telematics device 106, valuation data for the associated vehicle 104 may be reported by a third party system 112 and stored with the telematics data in the blockchain.

The processing server 102 may thus possess or otherwise have access to telematics data, characteristics data, and valuation data for a plurality of different vehicles 104. In the system 100, the user 108 may request a valuation for a specific vehicle 104, referred to herein as the “target vehicle.” The user 108 may be any individual or entity interested in the valuation of a vehicle 104, such as a buyer, seller, dealership, insurer, investigator, accountant, etc. For example, the user 108 may be an individual that is turning a vehicle 104 in to a dealership when looking to buy a new car. In another example, the user 108 may be an employee of a dealership looking to evaluate a vehicle 104 someone wants to sell or turn in to the dealership. In yet another example, the user 108 may be an insurance company that desires a valuation of the vehicle 104 for use in creating an insurance policy for the vehicle 104.

The user 108 may submit a request for a valuation to the processing server 102 via the computing device 110. The request may include at least the telematics data captured from the vehicle 104 by the telematics device 106 or an indication of the telematics data that may have been previously reported to the processing server 102. For instance, if the telematics device 106 automatically reports the telematics data to a blockchain node, the request submitted by the computing device 110 may reference the reported telematics data, such as by vehicle identification number, a combination of characteristics data, a blockchain data value identifier, or other suitable information. The processing server 102 may receive the request and identify the telematics data accordingly. In some cases, the computing device 110 may also submit characteristics data to the processing server 102. In some such cases, the computing device 110 may reference telematics data but may directly submit the characteristics data (e.g., as supplied to the computing device 110 by the user 108 when instructing the computing device 110 to submit the request). In some embodiments, the computing device 110 may include data for use by the processing server 102 in establishing communication with a telematics device 106 installed in the target vehicle 104, where the processing server 102 may utilize the data to request the telematics data from the telematics device 106.

The processing server 102 may use the telematics data, and any other data associated therewith, to identify an estimated value of the target vehicle 104. The processing server 102 may analyze the received telematics data and compare it to the telematics data for every other vehicle 104 that is included in its database (e.g., or blockchain, as applicable). In cases where characteristics data may be available, the processing server 102 may compare telematics data for the target vehicle 104 with other vehicles 104 that share characteristics data. For example, the telematics data for the target vehicle 104 may be compared to telematics data for other vehicles 104 having the same make, model, year, and trim, or with other vehicles 104 sharing a drivetrain, transmission type, dry weight, and wheelbase. In some cases, the processing server 102 may identify a single vehicle 104 whose telematics data matches the telematics data for the target vehicle 104 more closely than any other vehicle. In other cases, the processing server 102 may identify a plurality of other vehicles where the telematics data is sufficiently close to the telematics data for the target vehicle 104, where the tolerance may be a predetermined amount (e.g., a 95% match) or may be adjustable such that a target number of other vehicles (e.g., ten) is identified.

Once one or more other vehicles 104 have been identified whose telematics data (e.g., and characteristics data, as applicable) matches the target vehicle 104, the processing server 102 may estimate a value for the target vehicle 104. The estimated value may be based on the value stored for each of the one or more other vehicles 104. In some cases, the value may be a median or mean of the values of the other vehicle(s) 104. In other cases, the value may be based on weighted values for each of the other vehicles 104 based on a strength of the match of the telematics data. For example, the target vehicle's telematics data may be matched to two other vehicles 104, where the target vehicle 104 has a 95% match to vehicle A and a 90% match to vehicle B. In this example, the estimated value of the target vehicle 104 may be closer to the value for vehicle A than vehicle B, due to the stronger match in telematics data. In some cases, vehicle values may be weighted by characteristics data in alternative or in addition to the telematics data. For example, if vehicle B and the target vehicle 104 share a trim, but vehicle A has a different trim, the value for vehicle B may be weighed more greatly when estimating the value of the target vehicle 104.

In some embodiments, the valuation of a vehicle 104 may also be based on additional criteria, such as the use of the valuation. For example, a vehicle 104 may be worth more when being sold to an independent individual than when being turned in to a dealership in exchange for another vehicle 104. In such embodiments, the valuation data for vehicles stored in the processing server 102 (e.g., or blockchain, as applicable) may indicate the use of the valuation. In these embodiments, the processing server 102 may use the data to identify multiple valuation estimates for the target vehicle 104 for each use, or may return a valuation that is associated with a particular use as requested by the computing device 110.

Once the estimate has been identified, the processing server 102 may report the estimate to the computing device 110. The user 108 may then review the value estimate for the target vehicle 104 and use it accordingly. In some embodiments, the user 108 may report a later identified value for the vehicle 104 to the processing server 102, such as an actual amount received or quoted when selling the target vehicle 104 to a dealership. In such an embodiment, the processing server 102 may use the valuation to store a new data entry in the database or blockchain for the target vehicle 104 that includes the vehicle's actual valuation, the telematics data, and any characteristics data. In some cases, the processing server 102 may also adjust its weighting or other algorithms based on the identified value for the vehicle 104 as compared to its estimate. For instance, the processing server 102 may weight individual values in telematics data based on feedback regarding identified values. For example, two vehicles 104 having nearly identical telematics data may receive two different valuations from dealerships, which may thus be attributed to the telematics data values that are different. For instance, the processing server 102 may identify that engine revolutions per minute when shifting has a higher effect on value of a vehicle 104 than average speed, and may weigh matches or estimated valuations accordingly, where the processing server 102 may continue to adjust such weights as feedback is received.

In some embodiments, the telematics data and/or valuations may be used to identify insurance premiums, estimated insurance coverage, or other valuations and identifications related to insurance. For instance, the third party system 112 may be an insurance provider that may be providing insurance to the user 108 for the vehicle 104. In such an instance, the insurance provider may view telematics data for the vehicle 104 as it is added to the blockchain, and may use it accordingly in updating valuations of the vehicle 104 and performing calculations related to the insurance thereof. In another example, multiple insurance providers may bid on providing insurance on the vehicle 104, such as by submitting proposed insurance premiums for selection by the user 108. In such an example, each insurance provider may view the telematics data on the blockchain (e.g., and estimated valuations from the blockchain or processing server 102, if applicable) and may use it to determine an insurance premium using its own internal methods. The insurance providers may each submit their proposals to the user 108, which may select one of the insurance providers to go with for insuring the vehicle 104. In some cases, the blockchain may be used to store the insurance premium bids, to provide for security and prevent fraud related thereto.

The methods and systems discussed herein provide for estimated valuations for vehicles 104 that are based on vehicle telematics data. Telematics data may provide for valuations that are based on objective data captured for a vehicle 104 that may not be available to users 108 or other entities that desire valuations of a vehicle, and may provide for more accurate valuations. The use of the processing server 102, specifically configured to perform the functions discussed herein, may provide for valuations that can be performed for users 108 without requiring a user 108 to gather any data, or gather a minimal amount of data, for a vehicle 104, which may greatly increase user convenience and enable more accurate valuations even in cases where a valuation may be difficult or impossible using traditional methods. In embodiments where telematics data may be stored in a blockchain, the accuracy of such data, and therefore of corresponding valuations, may be even greater as the data may be protected from tampering or falsification. For example, a seller may misrepresent the condition of a vehicle 104 to a potential buyer; however, using the processing server 102, the potential buyer may get a proper valuation for the vehicle 104 as the seller would be unable to falsify the telematics data in the blockchain, and thus be protected from the attempted fraud on the part of the seller.

### Processing Server

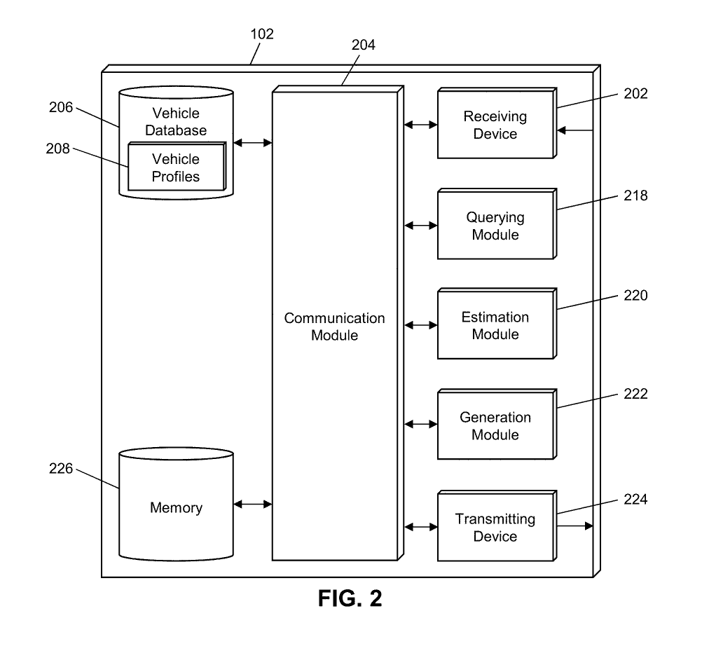

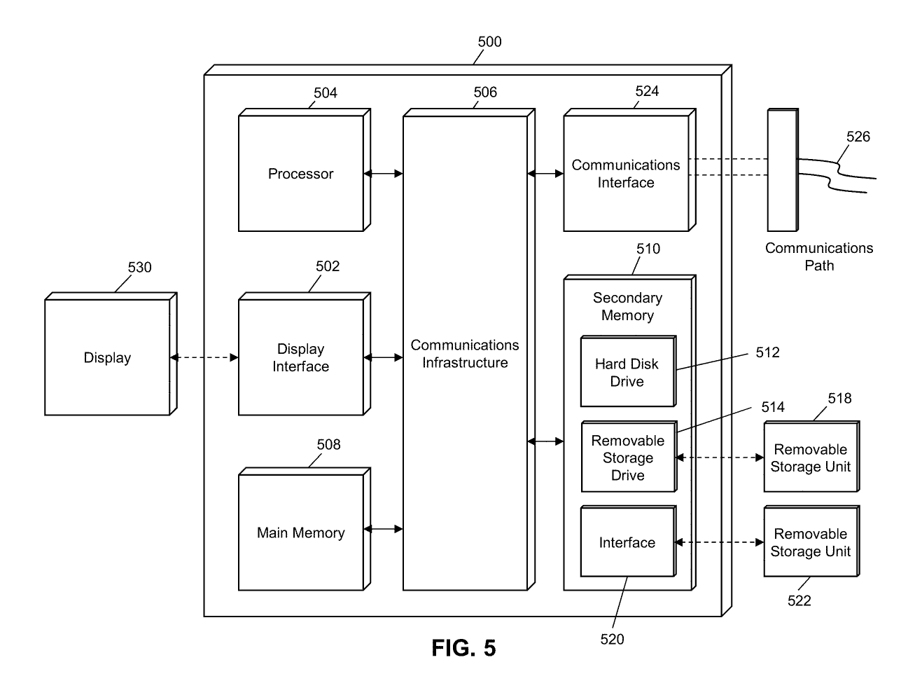

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from telematics devices 106, computing devices 110, third party systems 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by telematics devices 106, computing devices 110, or third party systems 112 that are superimposed or otherwise encoded with telematics data for a vehicle 104. In some cases, the telematics data may be accompanied by characteristics data and/or value data for a vehicle 104. In some instances, the data may be include as a data value included in a blockchain received by the receiving device 202, such as from a node in a blockchain network as the third party system 112. The receiving device 202 may also be configured to receive data signals electronically transmitted by computing devices 110 that may be superimposed or otherwise encoded with a valuation request, which may include telematics data or data used in the identification of telematics data for a vehicle 104, such as vehicle identification data, characteristics data, etc. In some cases, the valuation request may include a valuation use, for use in identifying a specific type of valuation for a target vehicle 104.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, estimation module 220, generation module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

In some embodiments, the processing server 102 may include a vehicle database 206. The vehicle database 206 may be configured to store a plurality of vehicle profiles 208 using a suitable data storage format and schema. The vehicle database 206 may be a relational database that utilizes structured query language for the storage, identification, modifying, updating, accessing, etc. of structured data sets stored therein. Each vehicle profile 208 may be a structured data set configured to store data related to a vehicle 104. A vehicle profile 208 may include at least telematics data received for the related vehicle 104 and may also include any other data received for the vehicle, such as characteristics data, communication data for an associated telematics device 106, valuations, etc. In some embodiments, the vehicle database 206 may be a blockchain, where each vehicle profile 208 may be a data value stored in a block in the blockchain.

The processing server 102 may include a querying module 218. The querying module 218 may be configured to execute queries on databases to identify information. The querying module 218 may receive one or more data values or query strings, and may execute a query string based thereon on an indicated database, such as the vehicle database 206, to identify information stored therein. The querying module 218 may then output the identified information to an appropriate engine or module of the processing server 102 as necessary. The querying module 218 may, for example, execute a query on the vehicle database 206 to identify one or more vehicle profiles 208 where the included telematics data matches telematics data received as part of a valuation request. In some cases, the querying module 218 may first identify a subset of vehicle profiles 208 that include characteristics data matching the characteristics of a target vehicle 104 and may then identify one or more vehicle profiles 208 in the subset where the telematics data matches, or is within a predetermined tolerance of, the telematics data for the target vehicle 104.

The processing server 102 may also include an estimation module 220. The estimation module 220 may be configured to estimate the value of a target vehicle 104 based on valuations of other vehicles 104 and matches of telematics data therewith. The estimation module 220 may receive the telematics data, characteristics data, and any other data included in a valuation request, as well as the data included in each of the identified vehicle profiles 208 as input, may estimate a value for the target vehicle 104, and output the estimated value to another module or engine of the processing server 102. As discussed above, the estimation module 220 may use weights based on strength of matches of telematics data and/or characteristics data, strength of matches of specific data values in telematics data, etc. In some cases, the estimation module 220 may estimate a plurality of different valuations for a target vehicle 104, such as for different uses of the valuation or based on different, unavailable characteristics data. For instance, the user 108 may request a valuation for a vehicle 104 without providing a transmission type, where the estimation module 220 may, based on available data, estimate a value for the target vehicle 104 for both automatic transmission and manual transmission, for the user 108 to use accordingly.

The processing server 102 may also include a generation module 222. The generation module 222 may be configured to generate data for use by the processing server 102 in performing the functions discussed herein. The generation module 222 may receive instructions as input, may generate data based on the instructions, and may output the generated data to another module or engine of the processing server 102. For example, the generation module 222 may be configured to generate a data message that includes a vehicle valuation for delivery to a computing device 110 in response to a received valuation request. In embodiments where the processing server 102 may be a node in a blockchain network, the generation module 222 may be configured to generate data values based on vehicle valuations and telematics data, hash values from block headers and/or date values, block headers, and new blocks for use in updating and maintaining the associated blockchain.

The processing server 102 may also include a transmitting device 224. The transmitting device 224 may be configured to transmit data over one or more networks via one or more network protocols. In some instances, the transmitting device 224 may be configured to transmit data to telematics devices 106, computing devices 110, third party systems 112, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to computing devices 110 that are superimposed or otherwise encoded with estimated values for a target vehicle 104, such as may be transmitted in response to a valuation request. The transmitting device 224 may also be configured to electronically transmit data signals to telematics devices 106, computing devices 110, or third party systems 112 that are superimposed or otherwise encoded with a telematics data request, which may include characteristics data or other vehicle identification data for the request of telematics data associated with the corresponding vehicle 104. In embodiments where the processing server 102 may be a node in a blockchain network, the transmitting device 224 may also be configured to electronically transmit data signals to other nodes in the blockchain network that are superimposed or otherwise encoded with new blocks for the validation thereof or validations of new blocks as performed by the processing server 102.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, weight values for characteristics, telematics match rates, telematics data values, etc., algorithms for valuations, adjustments for valuation types, etc.

### Process for Identifying a Vehicle Value Based on Telematics

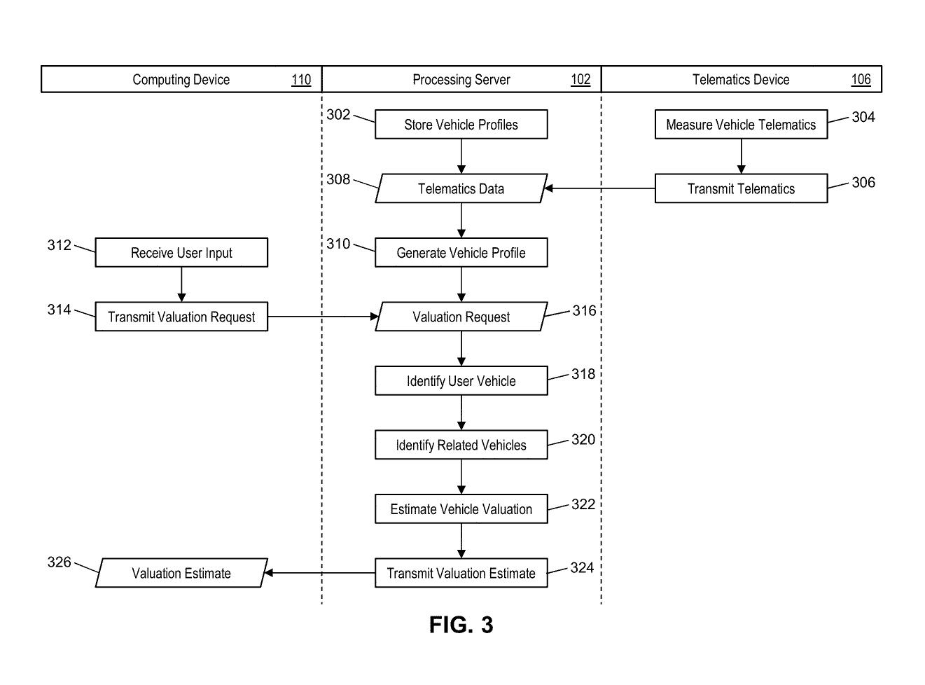

FIG. 3 illustrates an example process in the system 100 of FIG. 1 for the identification of the valuation of a vehicle 104 by the processing server 102 based on telematics data.

In step 302, the querying module 218 of the processing server 102 may insert a plurality of vehicle profiles 208 in the vehicle database 206 of the processing server 102, where each vehicle profile 208 includes telematics, characteristics, and valuation data for a related vehicle 104. In some embodiments, each vehicle profile 208 may be a data value included in a block of a blockchain comprising the vehicle database 206. Step 302 may be carried out by the processing server 102 over a period of time, where new vehicle profiles 208 are inserted into the vehicle database 206 as such data is received by the processing server 102, such as from dealerships, insurance companies, reporting agencies, etc.

In step 304, the telematics device 106 installed in the target vehicle 104 may measure telematics for the vehicle 104 over the course of its operation. In step 306, the telematics devices 106 may electronically transmit the measured telematics data to the processing server 102 either directly or via one or more intermediate entities, such as a third party system 112. The telematics data may include data identifying the target vehicle 104, such as a vehicle identification number, which may also or alternatively include characteristics data associated with the target vehicle 104. In step 308, the receiving device 202 of the processing server 102 may receive the telematics data from the telematics device 106. In step 310, the querying module 218 of the processing server 102 may execute a query on the vehicle database 206 to insert a new vehicle profile 208 for the target vehicle 104 that includes the received telematics data and any other data provided by the telematics device 106, such as the vehicle identification number.

In step 312, the computing device 110 may receive input from the user 108 requesting a valuation request for the target vehicle 104 be submitted. As part of the input, the user 108 may select identification data for the vehicle 104, such as the vehicle identification number, and supply any characteristics data associated therewith. In some cases, the user 108 may only supply characteristics data if such data was not provided by the telematics device 106 in step 306. In step 314, the computing device 110 may electronically transmit a valuation request to the processing server 102. The valuation request may include the vehicle identification data, characteristics data, if applicable, and may also include a use of the valuation if a specific type of valuation is requested by the user 108, such as a valuation for resale to a third party.

In step 316, the receiving device 202 of the processing server 102 may receive the valuation request. In step 318, the querying module 218 of the processing server 102 may execute a query on the vehicle database 206 to identify the vehicle profile 208 (e.g., generated in step 310) that is associated with the target vehicle 104 using the identification data included in the valuation request. In step 320, the querying module 218 may execute a query on the vehicle database 206 to identify a set of vehicle profiles 208 related to vehicles that are related to the target vehicle 104, such as vehicles that share characteristics data with the target vehicle 104, such as vehicles having the same make, model, year, and trim. In step 322, the estimation module 220 of the processing server 102 may estimate a value of the target vehicle 104 based on a comparison of its telematics data to the telematics data included in each of the vehicle profiles 208 included in the subset and the values for each of the other vehicles as indicated in the respective vehicle profiles 208. In some cases, the estimation module 220 may weigh the values of each of the other vehicles based on a strength of the match between that vehicle's telematics data and the telematics data for the target vehicle 104.

In step 324, the transmitting device 224 of the processing server 102 may electronically transmit the estimated value of the target vehicle 104 to the computing device 110. In step 326, the computing device 110 may receive the valuation estimate. The computing device 110 may then be free to present the valuation to the user 108, who may use the valuation accordingly. For instance, in the above example, the user 108 may present the valuation estimate to an interested third party when attempting to sell the target vehicle 104 to provide for a basis for a stated selling price.

### Exemplary Method for Valuation of a Vehicle Based on Telematics

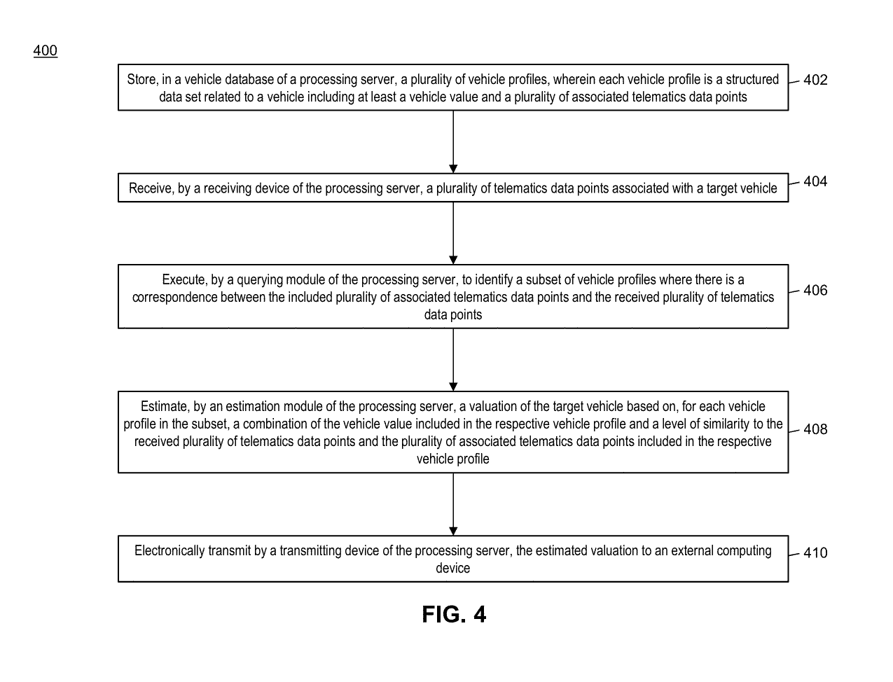

FIG. 4 illustrates a method 400 for the valuation of a vehicle based on telematics for the vehicle as compared to telematics for a plurality of different vehicles of known values.

In step 402, a plurality of vehicle profiles (e.g., vehicle profiles 208) may be stored in a vehicle database (e.g., the vehicle database 206) of a processing server (e.g., the processing server 102), wherein each vehicle profile is a structured data set related to a vehicle (e.g., a vehicle 104) including at least a vehicle value and a plurality of associated telematics data points. In step 404, a plurality of telematics data points associated with a target vehicle may be received by a receiving device (e.g., the receiving device 202) of the processing server. In step 406, a query may be executed on the vehicle database by a querying module (e.g., the querying module 218) of the processing server to identify a subset of vehicle profiles where there is a correspondence between the included plurality of associated telematics data points and the received plurality of telematics data points.

In step 408, a valuation of the target vehicle may be estimated by an estimation module (e.g., the estimation module 220) of the processing server based on, for each vehicle profile in the subset, a combination of the vehicle value included in the respective vehicle profile and a level of similarity to the received plurality of telematics data points and the plurality of associated telematics data points included in the respective vehicle profile. In step 410, the estimated valuation may be electronically transmitted by a transmitting device (e.g., the transmitting device 224) of the processing server to an external computing device (e.g., the computing device 110).

In one embodiment, the vehicle database may be a blockchain comprised of a plurality of blocks, each block may include at least a block header and one or more data values, and each vehicle profile may be a data value included in the one or more data values included in the plurality of blocks. In some embodiments, each vehicle profile may further include a vehicle model identifier, the plurality of telematics data points may be accompanied by a specific vehicle model identifier, and the vehicle model identifier included in each vehicle profile in the subset of vehicle profiles may be the specific vehicle model identifier. In one embodiment, the plurality of telematics data points may be received from a reading device (e.g., the telematics device 106) directly interfaced with the target vehicle separate from the external computing device.

In some embodiments, the method 400 may further include receiving, by the receiving device of the processing server, a valuation request, wherein each vehicle profile further includes a reported condition of the related vehicle, the valuation request includes a specific reported condition, and the reported condition included in each vehicle profile in the subset of vehicle profiles is the specific reported condition. In a further embodiment, the valuation request may be received from the external computing device. In an even further embodiment, the plurality of telematics data points may be received from a reading device directly interfaced with the target vehicle separate from the external computing device. In a yet further embodiment, the valuation request may further include a vehicle identifier, and the plurality of telematics data points may be accompanied by the vehicle identifier.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for valuation of a vehicle based on telematics. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for valuation of a vehicle based on telematics, comprising:
storing, in a vehicle database of a processing server, a plurality of vehicle profiles, wherein each vehicle profile is a structured data set related to a vehicle including at least a vehicle value and a plurality of associated telematics data points;
receiving, by a receiving device of the processing server, a plurality of telematics data points associated with a target vehicle;
executing, by a querying module of the processing server, to identify a subset of vehicle profiles where there is a correspondence between the included plurality of associated telematics data points and the received plurality of telematics data points;
estimating, by an estimation module of the processing server, a valuation of the target vehicle based on, for each vehicle profile in the subset, a combination of the vehicle value included in the respective vehicle profile and a level of similarity to the received plurality of telematics data points and the plurality of associated telematics data points included in the respective vehicle profile; and
electronically transmitting, by a transmitting device of the processing server, the estimated valuation to an external computing device.

2. The method of claim 1, wherein
the vehicle database is a blockchain comprised of a plurality of blocks,
each block includes at least a block header and one or more data values, and
each vehicle profile is a data value included in the one or more data values included in the plurality of blocks.

3. The method of claim 1, wherein
each vehicle profile further includes a vehicle model identifier,
the plurality of telematics data points is accompanied by a specific vehicle model identifier, and
the vehicle model identifier included in each vehicle profile in the subset of vehicle profiles is the specific vehicle model identifier.

4. The method of claim 1, further comprising:
receiving, by the receiving device of the processing server, a valuation request, wherein
each vehicle profile further includes a reported condition of the related vehicle,
the valuation request includes a specific reported condition, and
the reported condition included in each vehicle profile in the subset of vehicle profiles is the specific reported condition.

5. The method of claim 4, wherein the valuation request is received from the external computing device.

6. The method of claim 5, wherein the plurality of telematics data points are received from a reading device directly interfaced with the target vehicle separate from the external computing device.

7. The method of claim 6, wherein
the valuation request further includes a vehicle identifier, and
the plurality of telematics data points is accompanied by the vehicle identifier.

8. The method of claim 1, wherein the plurality of telematics data points are received from a reading device directly interfaced with the target vehicle separate from the external computing device.

9. The method of claim 1, further comprising:
estimating, by the estimation module of the processing server, insurance coverage for the target vehicle based on at least the estimated valuation, wherein
the estimated insurance coverage is electronically transmitted with the estimated valuation.

10. A method for valuation of a vehicle based on telematics, comprising:
a vehicle database of a processing server configured to store a plurality of vehicle profiles, wherein each vehicle profile is a structured data set related to a vehicle including at least a vehicle value and a plurality of associated telematics data points;
a receiving device of the processing server configured to receive a plurality of telematics data points associated with a target vehicle;
a querying module of the processing server configured to execute a query to identify a subset of vehicle profiles where there is a correspondence between the included plurality of associated telematics data points and the received plurality of telematics data points;
an estimation module of the processing server configured to estimate a valuation of the target vehicle based on, for each vehicle profile in the subset, a combination of the vehicle value included in the respective vehicle profile and a level of similarity to the received plurality of telematics data points and the plurality of associated telematics data points included in the respective vehicle profile; and
a transmitting device of the processing server configured to electronically transmit the estimated valuation to an external computing device.

11. The system of claim 10, wherein
the vehicle database is a blockchain comprised of a plurality of blocks,
each block includes at least a block header and one or more data values, and
each vehicle profile is a data value included in the one or more data values included in the plurality of blocks.

12. The system of claim 10, wherein
each vehicle profile further includes a vehicle model identifier,
the plurality of telematics data points is accompanied by a specific vehicle model identifier, and
the vehicle model identifier included in each vehicle profile in the subset of vehicle profiles is the specific vehicle model identifier.

13. The system of claim 10, wherein
the receiving device of the processing server is further configured to receive a valuation request,
each vehicle profile further includes a reported condition of the related vehicle,
the valuation request includes a specific reported condition, and
the reported condition included in each vehicle profile in the subset of vehicle profiles is the specific reported condition.

14. The system of claim 13, wherein the valuation request is received from the external computing device.

15. The system of claim 14, wherein the plurality of telematics data points are received from a reading device directly interfaced with the target vehicle separate from the external computing device.

16. The system of claim 15, wherein
the valuation request further includes a vehicle identifier, and
the plurality of telematics data points is accompanied by the vehicle identifier.

17. The system of claim 10, wherein the plurality of telematics data points are received from a reading device directly interfaced with the target vehicle separate from the external computing device.

18. The system of claim 10, wherein
the estimation module of the processing server is further configured to estimate insurance coverage for the target vehicle based on at least the estimated valuation, and
the estimated insurance coverage is electronically transmitted with the estimated valuation.
